(19) United States
(12) Patent Application Publication
(10) Pub. No.: US 2009/0140203 A1
(43) Pub. Date: Jun. 4, 2009

(54) Rare earth nano phosphor and method of preparing the same

(76) Inventors: Hyun-sik Kim, Yongin-si (KR); Soon-jae Kwon, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/081,405

(22) Filed: Apr. 15, 2008

(30) Foreign Application Priority Data
Nov. 29, 2007 (KR) 10-2007-0122736

(51) Int. Cl. C09K 11/84

(52) U.S. Cl. 252/301.4 S

(57) ABSTRACT

Provided are a rare earth nano phosphor and a method of preparing a rare earth nano phosphor, the method includes: (a) synthesis of rare earth nano phosphor precursor particles by radiating microwave energy to a solvent where rare earth metal compounds are dissolved; and (b) sintering of inorganic salt and the rare earth nano phosphor precursor mixture.

### CLAIM OF PRIORITY

This application makes reference to, incorporates the same herein, and claims all benefits accruing under 35 U.S.C. §119 from an application earlier filed in the Korean Intellectual Property Office on Nov. 29, 2007 and there duly assigned Serial No. 10-2007-0122736.

### BACKGROUND OF THE INVENTION

1. Field of the Invention

The present invention relates to a rare earth nano phosphor and a method of preparing a rare earth nano phosphor.

2. Description of the Related Art

A phosphor is a material that emits light when excited by energy. In general, phosphors are used in a light source, such as a mercury fluorescent lamp or a mercury-free fluorescent lamp; or in various devices, such as a field emission device or a plasma display panel. In the future, phosphors are expected to be used in a wider range of applications as newly developed multimedia devices are introduced.

The present invention calls a nano-sized phosphor as a nano phosphor, and when applied to a device, nano phosphor can reduce the loss due to a light scattering effect which is a problem with bulk-sized conventional phosphor.

Properties required to nano phosphors include small sizes, non-aggregated particle distribution, and excellent luminous efficiency. However, small and non-aggregated phosphors tend to show low luminous efficiency, and when the sintering temperature or time is increased to obtain high luminous efficiency, particles of phosphor may agglomerate among themselves and becoming greater in size. This is a fundamental problem encountered when nano phosphors are prepared by conventional method. Such problems can be resolved by using a spray pyrolysis method or a laser pyrolysis method. These methods secure excellent properties, but are expensive and unsuitable for mass production.

### SUMMARY OF THE INVENTION

The present invention provides a rare earth nano phosphor having an excellent luminous efficiency.

The present invention also provides a method of preparing a rare earth nano phosphor whose size, shape and degree of aggregation are controlled.

According to an aspect of the present invention, there is provided a rare earth nano phosphor having an average particle diameter of 50 to 600 nm.

The rare earth nano phosphor may be represented by Formula 1:

M₍₂₋ₓ₎NₓO₂SO_{y} <Formula 1>

where M includes at least one kind of element selected from the group consisting of Y, Lu, La, Ce, Pr, Nd, Sm, Eu, Gd, Tb, Dy, Ho, Er, Tm, and Yb; N includes at least one kind of element selected from the group consisting of Y, Lu, La, Ce, Pr, Nd, Sm, Eu, Gd, Tb, Dy, Ho, Er, Tm, and Yb; 0≦x≦2; and 0≦y<4.

According to another aspect of the present invention, there is provided a method of preparing a rare earth nano phosphor, the method includes:

(a) synthesis of rare earth nano phosphor precursor particles by radiating microwave energy to a solvent where rare earth metal compounds are dissolved; and

(b) sintering of inorganic salt and the rare earth nano phosphor precursor mixture.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a method of preparing a rare earth nano phosphor according to an embodiment of the present invention;

FIG. 2 is an scanning electron microscopic (SEM) image of a rare earth nano phosphor represented by Y₂O₂SO₄:Eu synthesized according to an embodiment of the present invention;

FIG. 3 is a transmission electron microscopic (TEM) image of a rare earth nano phosphor represented by Y₂O₂SO₄:Eu synthesized according to an embodiment of the present invention;

FIG. 4 is an SEM image of a rare earth nano phosphor represented by Y₂O₂SO₄:Eu synthesized without an inorganic salt;

FIG. 5 is an X-ray diffraction (XRD) graph of a rare earth nano phosphor represented by Y₂O₂SO₄:Eu synthesized according to an embodiment of the present invention;

FIG. 6 is a graph showing a particle size distribution of a rare earth nano phosphor represented by Y₂O₂SO₄:Eu synthesized according to an embodiment of the present invention, which was measured using a laser scattering method;

FIG. 7 is a graph illustrating the photoluminescence (PL) emission spectrum of a rare earth nano phosphor represented by Y₂O₂SO₄:Eu according to an embodiment of the present invention when the rare earth nano phosphor is excited at 254 nm; and

FIG. 8 is a graph illustrating the PL excitation spectrum of a rare earth nano phosphor represented by Y₂O₂SO₄:Eu according to an embodiment of the present invention when the rare earth nano phosphor is emitted at 619 nm.

### DETAILED DESCRIPTION OF THE INVENTION

The present invention will now be described in more detail with reference to the accompanying drawings, in which exemplary embodiments of the invention are shown.

A rare earth nano phosphor according to the present invention has an average particle size of 50 to 600 nm.

When the average particle size of a rare earth nano phosphor according to an embodiment of the present invention is greater than 600 nm, nano phosphor does not have significant advantages on scattering effect over conventional bulk-sized phosphor.

The rare earth nano phosphor can be a compound represented by Formula 1:

M₍₂₋ₓ₎NₓO₂SO_{y} <Formula 1>

where M includes at least one kind of element selected from the group consisting of Y, Lu, La, Ce, Pr, Nd, Sm, Eu, Gd, Tb, Dy, Ho, Er, Tm, and Yb; 0≦x≦2; N includes at least one kind of element selected from the group consisting of Y, Lu, La, Ce, Pr, Nd, Sm, Eu, Gd, Tb, Dy, Ho, Er, Tm, and Yb; 0≦x≦2; and 0≦y<4.

For example, a difference between 10%-point of cumulative particle size distribution (D10) and 90%-point of cumulative particle size distribution (D90) of rare earth nano phosphor particles may be in a range of 80-900 nm.

D10 and D90 may be measured using any method that is known to one of ordinary skill in the art, such as TEM or SEM. Alternatively, a measuring device using a dynamic light-scattering method may be used. As the resulting data includes the number of particles at given size range, the value of D10 and D90 can be easily obtained. With respect to rare earth nano phosphor particles according to an embodiment of the present invention, D10 may be in a range of 10 to 100 nm and D90 may be in a range of 90 to 1000 nm.

When the difference between D10 and D90 is large, individual particles may have a wide particle size distribution; on the other hand, when the difference between D10 and D90 is small, individual particles may have a small particle size distribution. Therefore, if the difference between D10 and D90 is larger than 900 nm, it shows that many particles are agglomerated to form clusters and thus many large particles are formed.

When the difference between D10 and D90 is 0, all particles have almost the same particle size. However, it is very difficult to obtain such particles having the same particle size in fact. The difference between D10 and D90 of the rare earth nano phosphor according to the present invention may be at least 80 nm.

A nano phosphor according to an embodiment of the present invention may be used in any LED that includes a phosphor.

Referring to FIG. 8, a nano phosphor according to an embodiment of the present invention has its peaks at 270 and 390 nm in the excitation spectrum thereof. Therefore, the nano phosphor can be used for UV-excited LED.

Also, a phosphor represented by Y₂₋ₓEuₓO₂SO₄ according to an embodiment of the present invention emits visible light when excited by X-ray energy, thus the phosphor is suitable for X-ray detection and an X-ray imaging system. Since the phosphor represented by Y₂₋ₓEuₓO₂SO₄ emits visible light when excited by X-ray and has a reduced visible light scattering effect when formed in nano sizes, the phosphor represented by Y₂₋ₓEuₓO₂SO₄ having nano size according to the present invention can be used in X-ray scintillator, instead of a monocrystal X-ray scintillator which is used in an X-ray imaging system. Since the size of phosphor particles can be reduced to nano meter range, which is smaller than the wavelength of visible light, the nano phosphor represented by Y₂₋ₓEuₓO₂SO₄ can be used in an X-ray scintillator instead of monocrystals.

Also, the present invention provides a method of preparing a rare earth nano phosphor, in which the method includes (a) synthesis of rare earth nano phosphor precursor particles by radiating microwave energy to a solvent where rare earth metal compounds are dissolved; and (b) sintering of inorganic salt and the rare earth nano phosphor precursor mixture.

The method will now be described in detail according to an embodiment of the present invention.

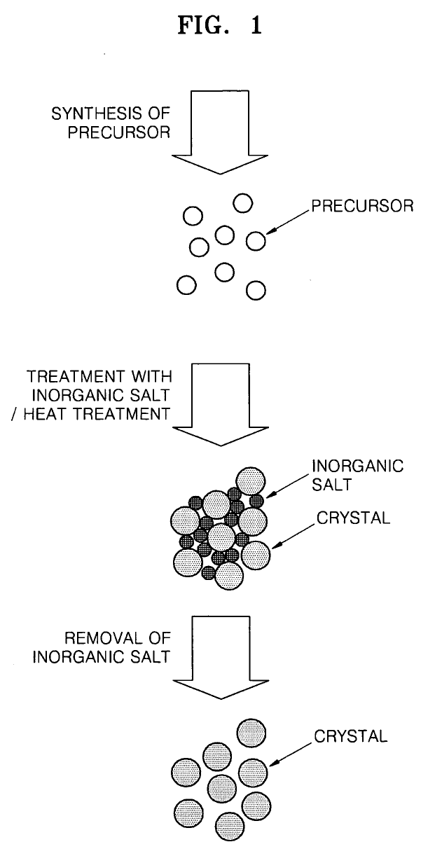

FIG. 1 is a schematic view illustrating a method of preparing rare earth nano phosphor according to an embodiment of the present invention.

Referring to FIG. 1, in process (a) of the method, rare earth metal precursor compounds which are to form a rare earth nano phosphor are dissolved in a solvent, and then the obtained solution is heat-treated to synthesize a rare earth nano phosphor precursor.

According to an embodiment of the present invention, the rare earth metal precursor compound can be represented by ML₃ where M is Y, Lu, La, Ce, Pr, Nd, Sm, Eu, Gd, Tb, Dy, Ho, Er, Tm, or Yb; and L is Cl, Br, NO₃, OCH₃, OC₂H₅, OC₃H₇, or OC₄H₉.

According to an embodiment of the present invention, in process (a) of the method, the heat treatment may be performed using a microwave to obtain uniform rare earth nano phosphor precursor particles.

According to an embodiment of the present invention, in process (a) of the method, a surfactant may be further used. According to an embodiment of the present invention, the surfactant used in process (a) may includes at least one compound selected from the group consisting of citric acid, acetic acid (CH₃COOH), sodium acetate (NaCOOCH₃), ammonium acetate (NH₄COOCH₃), oleic acid, sodium oleat (C₁₇H₃₃COONa), ammonium oleate (C₁₇H₃₃COONH₄), ammonium succinate (NH₄COOCH₂CH₂COONH₄), polyacrylate, glycine, and acylglutamate. By using the surfactant, the size of nano phosphor particles may be controlled.

As illustrated in FIG. 1, in the treating with an inorganic salt, the rare earth nano phosphor precursor particles prepared in process (a) are treated with an inorganic salt such that the inorganic salt is present among rare earth precursor particles.

According to an embodiment of the present invention, the inorganic salt may include at least one compound selected from the group consisting of MgSO₄, Li₂SO₄, Na₂SO₄, K₂SO₄, Rb₂SO₄, and (NH₄)₂SO₄.

When the inorganic salt is mixed with the rare earth nano phosphor precursor particles, SO₄²-salt of the inorganic salt reacts with the rare earth nano phosphor precursor particles to form rare earth nano phosphor particles. Also, the inorganic salt acts as a boundary between the rare earth nano phosphor particles so that agglomeration of rare earth nano phosphor particles may be prevented.

According to an embodiment of the present invention, after the rare earth nano phosphor precursor particles are treated with an inorganic salt, a heat treatment process was performed to obtain rare earth nano phosphor particles. The heat treatment process may be performed in the same conditions as known in conventional heat treatment processes.

As illustrated in FIG. 1, when the rare earth nano phosphor precursor particles are formed and then the formed rare earth nano phosphor precursor particles are treated with an inorganic salt according to an embodiment of the present invention, the inorganic salt may permeate between the rare earth nano phosphor precursor particles to act as a boundary therebetween.

After the heat treatment, the inorganic salt that is present between rare earth nano phosphor particles can be removed using a washing process. In this regard, a washing solution that is used in the washing process can be any polar solvent that dissolves the inorganic salt to remove the inorganic salt.

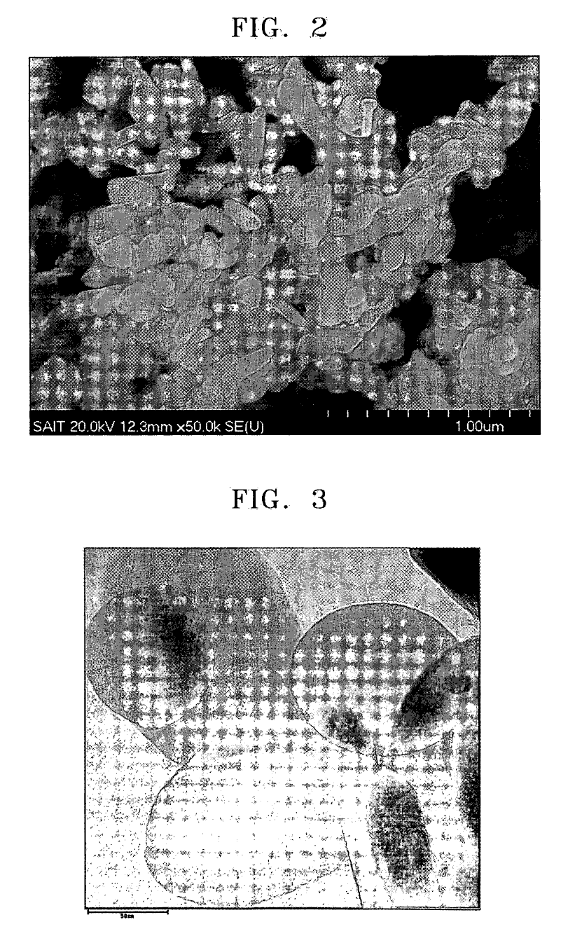

FIG. 2 is an scanning electron microscopic (SEM) image of a rare earth nano phosphor represented by Y₂O₂SO₄:Eu synthesized according to an embodiment of the present invention, and FIG. 3 is a transmission electron microscopic (TEM) image of a rare earth nano phosphor represented by Y₂O₂SO₄:Eu synthesized according to an embodiment of the present invention.

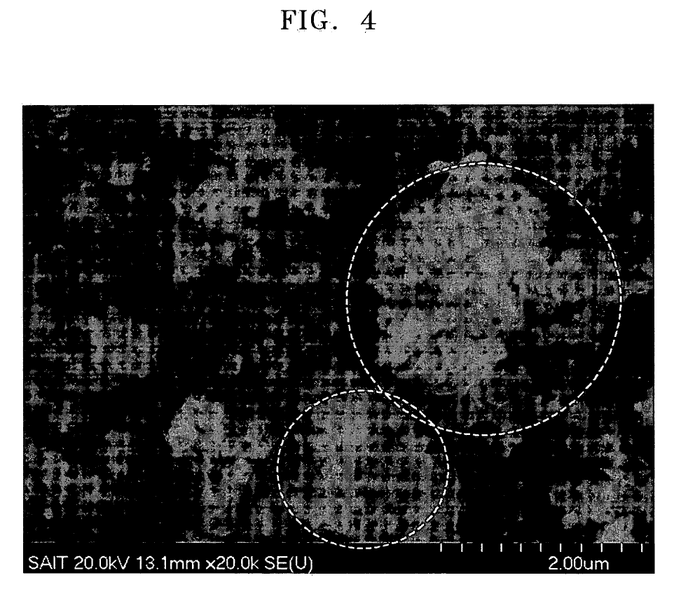

FIG. 4 is an SEM image of a rare earth nano phosphor synthesized without the inorganic salt. FIG. 6 is a graph showing a particle size distribution of a rare earth nano phosphor synthesized according to an embodiment of the present invention, which was measured using a laser scattering method.

Referring to FIG. 4, it is identified that particles of the rare earth nano phosphor prepared without the inorganic salt are agglomerated to form clusters.

Referring to FIGS. 2 and 3, a rare earth nano phosphor prepared by treating with the inorganic salt according to an embodiment of the present invention have a controlled shape, that is, the particles of the rare earth nano phosphor is spherical. In addition, particles of the rare earth nano phosphor have a relatively uniform size, and may not be agglomerated.

Referring to FIG. 6, the nano phosphor prepared by treating with the inorganic salt according to an embodiment of the present invention has a uniform particle size distribution.

Also, the method of preparing a rare earth nano phosphor according to the present invention is inexpensive compared to a conventional method of preparing nano phosphor using expensive equipments.

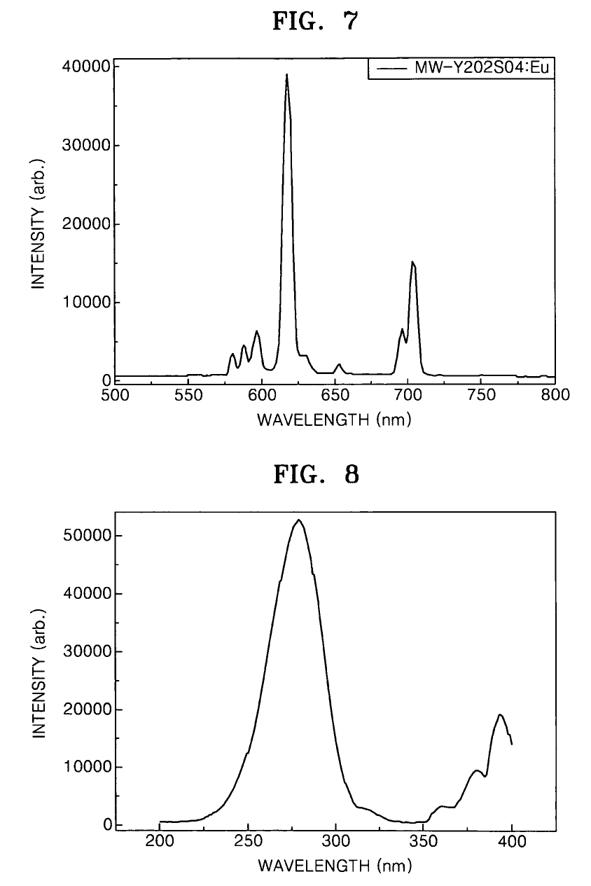

FIG. 7 is a graph illustrating the emission spectrum of the rare earth nano phosphor according to an embodiment of the present invention when the rare earth nano phosphor is excited at 254 nm. Referring to FIG. 7, it is identified that the rare earth nano phosphor according to an embodiment of the present invention has its peak at 619 nm in a red emission region when excited at 254 nm.

FIG. 8 is a graph illustrating the excitation spectrum of the rare earth nano phosphor according to an embodiment of the present invention when the rare earth nano phosphor emits light of 619 nm. Referring to FIG. 7, it is identified that the rare earth nano phosphor according to an embodiment of the present invention shows high excitation intensity at 279 nm and 393 nm at 619 nm emission wavelength.

Referring to FIGS. 7 and 8, the rare earth nano phosphor prepared according to an embodiment of the present invention has uniform nano sizes and thus excellent luminous efficiency can be obtained.

The present invention will be described in further detail with reference to the following examples. These examples are for illustrative purposes only and are not intended to limit the scope of the present invention.

### EXAMPLE 1

### Preparation of Rare Earth Nano Phosphor Represented by Y₂O₂SO₄:Eu Using Inorganic Salt

3.830 g of Y(NO₃)₃.6H₂O, 0.428 g of Eu(NO₃)₃.5H₂O, and 10.0 g of urea (NH₂CONH₂) which are starting materials were dissolved in 200 ml of distilled water, and then 800 W of microwave was irradiated thereto for 5-10 minutes in an ambient pressure to synthesize Y—O:Eu precursor particles represented by [Y₁₋ₓEuₓ(OH)CO₃].

Y—O:Eu precursor particles were mixed with an aqueous MgSO₄-saturated solution, dried, and then heated in the air at 900° C. for 1.5 hours so as to crystallize YBO₃:Eu particles. Then, distilled water was used to remove MgSO₄ to obtain Y₂O₂SO₄:Eu particles. The obtained Y₂O₂SO₄:Eu phosphor particles were identified using SEM and TEM images, which are shown in FIG. 2 and FIG. 3, respectively.

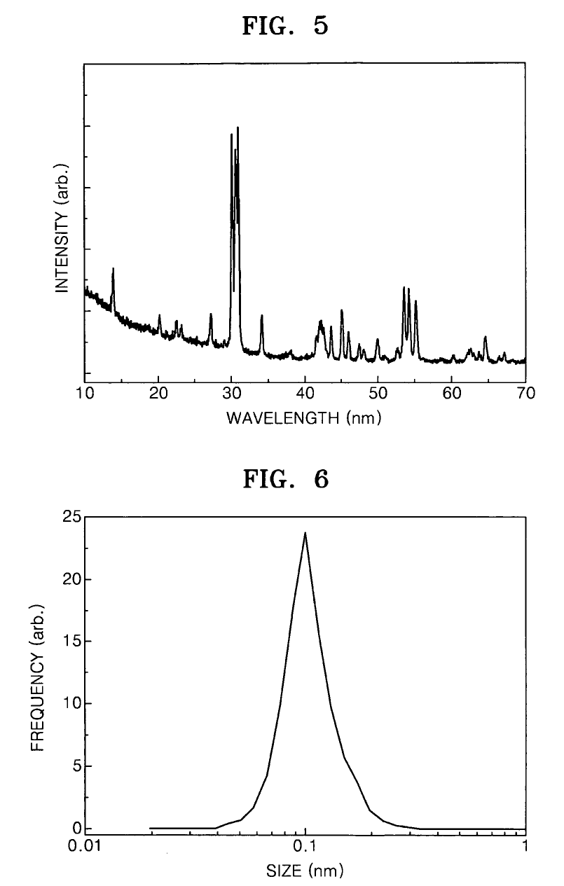

FIG. 5 is an X-ray diffraction (XRD) graph of the nano phosphor Y₂O₂SO₄:Eu synthesized according to Example 1.

### COMPARATIVE EXAMPLE 1

### Preparation of Rare Earth Nano Phosphor Represented by Y₂O₃:Eu Nano Phosphor without Inorganic Salt

3.830 g of Y(NO₃)₃.6H₂O, 0.428 g of Eu(NO₃)₃.5H₂O, 10.0 g of urea (NH₂CONH₂) which are precursors were dissolved in 200 ml of distilled water, and then 800 W of microwave was irradiated thereto for 5-10 minutes in an ambient pressure to synthesize Y—O:Eu precursor particles represented by [Y₁₋ₓEuₓ(OH)CO₃]; Then, the Y—O:Eu precursor particles were heated in the air at 900° C. for 1.5 hours so as to crystallize Y₂O₃:Eu particles. The obtained Y₂O₃:Eu particles were identified using its SEM image, which is shown in FIG. 4.

Referring to FIG. 4, it was identified that nano phosphor prepared according to Comparative Example 1 is agglomerated.

### EXPERIMENTAL EXAMPLE 1

### Identification of Distribution of Rare Earth Nano Phosphor Particles

The distribution of rare earth nano phosphor particles prepared according to Example 1 was measured using a laser scattering method. The results are shown in FIG. 6.

As illustrated in FIG. 6, particles of the rare earth nano phosphor prepared according to Example 1 have an average particle size of about 100 nm. The rare earth nano phosphor was prepared according to Example 1 in which a surfactant was used. The size of the nano phosphor particles can be controlled according to the kind of the surfactant being used.

### EXPERIMENTAL EXAMPLE 2

### Identification of Luminous Properties of Rare Earth Nano Phosphor

Luminous properties of rare earth nano phosphor particles prepared according to Example 1 were measured using an emission spectrum obtained using 254 nm of an exciting light and an excitation spectrum obtained at an emission wavelength of 619 nm, which are respectively shown in FIG. 7 and FIG. 8.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Rare earth nano phosphor particles which have an average particle size of 50 to 600 nm, wherein a difference between 10%-point of cumulative particle size distribution (D10) and 90%-point of cumulative particle size distribution (D90) is in a range of 80-900 nm.

2. The rare earth nano phosphor particles of claim 1, wherein the rare earth nano phosphor particles are represented by Formula 1:
M₍₂₋ₓ₎NₓO₂SO_{y} <Formula 1>
where M includes at least one kind of element selected from the group consisting of Y, Lu, La, Ce, Pr, Nd, Sm, Eu, Gd, Tb, Dy, Ho, Er, Tm, and Yb; N includes at least one kind of element selected from the group consisting of Y, Lu, La, Ce, Pr, Nd, Sm, Eu, Gd, Tb, Dy, Ho, Er, Tm, and Yb; 0≦x≦2; and 0≦y<4.

3. The rare earth nano phosphor particles of claim 1, being used in a LED.

4. The rare earth nano phosphor particles of claim 1, being used in an X-ray image device.

5. A method of preparing a rare earth nano phosphor, the method includes:
(a) synthesis of rare earth nano phosphor precursor particles by radiating microwave energy to a solvent where rare earth metal compounds are dissolved; and
(b) sintering of inorganic salt and the rare earth nano phosphor precursor mixture.

6. The method of claim 5, after process (b), further comprising washing of the inorganic salt.

7. The method of claim 5, wherein the inorganic salt comprises at least one compound selected from the group consisting of MgSO₄, Li₂SO₄, Na₂SO₄, K₂SO₄, Rb₂SO₄ and (NH₄)₂SO₄.

8. The method of claim 5, wherein, in process (a), a surfactant is additionally used.

9. The method of claim 8, wherein the surfactant comprises at least one compound selected from the group consisting of citric acid, acetic acid (CH3COOH), sodium acetate (NaCOOCH₃), ammonium acetate (NH₄COOCH₃), oleic acid, sodium oleat (C₁₇H₃₃COONa), ammonium oleate (C₁₇H₃₃COONH₄), ammonium succinate (NH₄COOCH₂CH₂COONH₄), polyacrylate, glycine, and acylglutamate.

10. The method of claim 5, wherein the rare earth metal precursor compounds are represented by ML₃ where M is Y, Lu, La, Ce, Pr, Nd, Sm, Eu, Gd, Tb, Dy, Ho, Er, Tm, or Yb; and L is Cl, Br, NO₃, OCH₃, OC₂H₅, OC₃H₇, or OC₄H₉.
